(19) United States
(12) Patent Application Publication
(10) Pub. No.: US 2012/0266443 A1
(43) Pub. Date: Oct. 25, 2012

(54) Method for Producing a Securing Object, Particularly in the Form of a Heat-Resistant Adhesive Closure

(76) Inventor: Konstantinos Poulakis, Hildrizhausen (DE)

(21) Appl. No.: 13/534,771

(22) Filed: Jun. 27, 2012

Related U.S. Application Data
(63) Continuation of application No. 12/735,988, filed on Sep. 23, 2010.

(30) Foreign Application Priority Data
Mar. 12, 2008 (DE) 10 2008 013 890.8

(51) Int. Cl. B23P 17/00

(52) U.S. Cl. 29/428

(57) ABSTRACT

A method for producing a securing object, particularly in the form of a heat-resistant adhesive closure, includes providing metal securing elements (9) having a hooked head (13) and a foot part in the form of a tang (11), providing a support structure (1) having a securing surface (3), introducing perforations (7) into the securing surface (3) for forming seats for receiving the tangs (11) of the securing elements (9), and inserting the tangs (11) of the securing elements (9) into the preformed perforations (7) of the securing surface (3).

### CROSS-REFERENCE TO RELATED APPLICATION

This application claims priority under 35 U.S.C. §120 to and is a continuation of U.S. patent application Ser. No. 12/735,988 filed Aug. 31, 2010 and entitled Method for Producing a Securing Object, Particularly in the Form of a Heat-Resistant Adhesive Closure, the entire subject matter thereof is incorporated herein by reference.

### FIELD OF THE INVENTION

The invention relates to a method for producing a securing object, particularly in the form of a heat-resistant adhesive closure part. The securing elements are attached to a backing structure and have a hooked head and a foot part in the form of a tang.

### BACKGROUND OF THE INVENTION

EP 1 047 539 B1 discloses a method for producing securing objects in which the securing elements are attached to a backing structure with mushroom-shaped hooked heads and a foot parts in the form of tangs. The known solution is a molding process in which the securing object is formed from molten polypropylene by an injection molding machine. Plastic-based adhesive closure systems in which these securing objects are advantageously employed for a host of applications are therefore the most common. The field of application of plastic-based adhesive closure systems is limited by the low temperature stability of the plastic material. To be able to use adhesive closure systems in those applications in which very high thermal and/or mechanical loads occur, DE 10 2006 015 145 A1 discloses securing systems in the form of metal adhesive closures. They enable prompt and simple attachment or connection of parts even under unfavorable conditions, with respect to thermal and mechanical loading, as is the case, for example, in the hot zones of engines, particularly, in third parts which are to be mounted in the engine compartment of an internal combustion engine in close proximity to the exhaust system.

### SUMMARY OF THE INVENTION

An object of the invention is to provide a method enabling simple and efficient production of securing objects in the form of an adhesive closure part characterized by high loading capacity, especially heat resistance.

This object is basically achieved according to the invention by a method in which a securing surface of a backing structure is perforated and the perforations are provided with prefabricated, metal, tang-like securing elements. Outfitting of the hole of each perforation can take place with very high production speeds by a shooting device. The material of the backing structure can be chosen from a plurality of heat-resistant materials. Specifically, it can be a metal sheet if especially high heat resistance is required. The securing elements themselves can likewise be easily and efficiently produced, for example, by cutting a metal wire into lengths and heading the wire pieces formed to make the hooked head, for example, in the shape of a mushroom.

Preferably, the tangs of the securing elements are not only inserted into the perforations of the backing surface, but are secured such that a high force can be transferred between the backing structure and the fixing elements.

In exemplary embodiments in which the backing structure is formed by a metal material, fixing can take place advantageously by solder connections.

Alternatively, the tangs can be secured by cementing in the perforations.

The tangs of the securing elements can be fixed by cementing in the perforations, especially in cases in which the backing structure is formed by a nonmetal, heat-resistant material, for example, a ceramic material or a carbon material.

To form the perforation of the securing surface of the backing structure, a bore pattern can be formed in which the bores follow one another in the linear direction and in a direction diverging from the straight line. Because the inserted securing elements are lined up not only in straight lines, the adhesive closure parts formed in this way are characterized not only by high retention force perpendicular to the closure plane, but also offer an intensified securing action against displacement along the closure plane.

This bore pattern can be executed such that succeeding bores are made along a wavy line.

The execution of perforation can be produced with very high production speeds by high-speed boring. Feed and positioning are sequence-controlled with high frequency. A high production rate can also be achieved with laser technology.

Preferably, bores are made in the securing surface at distances from one another roughly four times the bore diameter. In this bore pattern the distance between the individual hooked heads of the securing elements is especially well-suited for hook engagement when the diameter of the preferably mushroom-shaped hooked heads is roughly 1.8 times the diameter of the tangs and thus of the bores.

Other objects, advantages and salient features of the present invention will become apparent from the following detailed description, which, taken in conjunction with the annexed drawings, discloses preferred embodiments of the present invention.

### BRIEF DESCRIPTION OF THE DRAWINGS

Referring to the drawings which form a part of this disclosure:

FIG. 1 is a top plan view of a backing structure shown enlarged roughly by a factor of 4 compared to a practical embodiment, with the perforating forming bores located in straight rows and columns, without the securing elements inserted into them according to a first exemplary embodiment of the invention;

FIG. 2 is a side elevational view in section of the backing structure taken along line II-II of FIG. 1;

FIG. 3 is a side elevational view in section corresponding to FIG. 2 and shown enlarged compared to it, with securing elements inserted into the perforations of the backing structure of FIG. 1;

FIG. 4 is a side elevational view of an individual, tang-like securing element, shown enlarged compared to a practical embodiment; and

FIG. 5 is a top view of a backing structure with perforation holes located along sine waves according to a second exemplary embodiment of the invention.

### DETAILED DESCRIPTION OF THE INVENTION

FIG. 1 shows in a plan view a backing structure according to a first exemplary embodiment of the securing object without securing elements attached to the backing structure 1. The backing structure 1 in the illustrated embodiment is formed by a metal plate with a square outline whose edge length is 28 mm in one practical embodiment. The top of the securing surface 3 of the backing structure 1 shown in FIG. 1 is surrounded along its four sides by edge strips 5 which are slightly elevated compared to the plane securing surface 3, in this practical embodiment by 0.2 mm. The material thickness of the backing structure 1 in the edge strips 5 is 1.7 mm. The material thickness within the securing surface 3 accordingly is 1.5 mm.

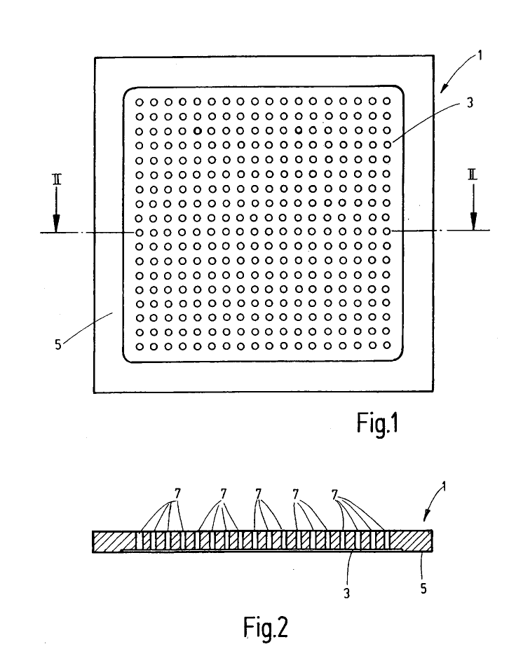

Within the securing surface 3, perforating is performed which, in the illustrated example, forms cylindrical bores 7 only numbered in FIG. 2. In the first exemplary embodiment shown in FIGS. 1 to 3, the bores 7 are located in straight rows and columns extending parallel to the edge strips 5. The rows and columns each containing 18 bores 7 so that the perforation comprises a total of 324 bores.

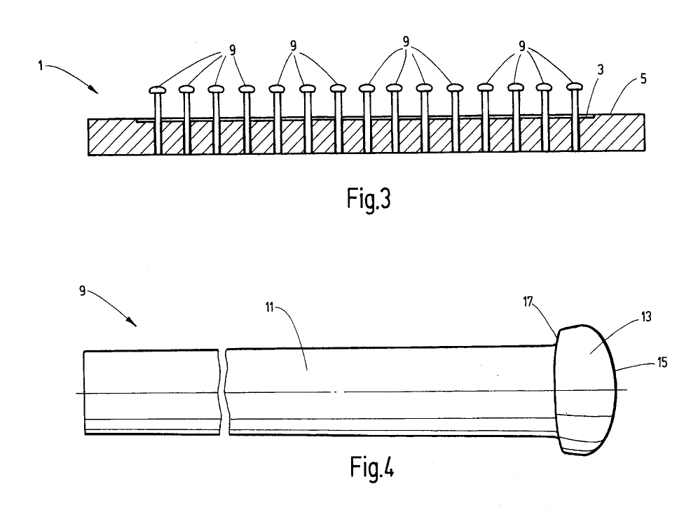

In the cross-sectional view of FIG. 3, a row of bores is shown provided with securing elements 9 after the holes are formed and before engagement of the securing elements with backing structure 1. These are metal parts in this exemplary embodiment are formed of copper. The shape of each element is apparent from the greatly enlarged FIG. 4. As shown, the hooked elements 9 each have a foot part in the form of a cylindrical tang 11 whose top end is formed by a hooked head 13 made in the shape of a mushroom. A head surface 15 is arched in the form of the arc of a circle. A hooked edge 17 is opposite the head surface 15 and projects laterally from the tang 11. In a perforation, the bores 7 have a diameter somewhat less than 0.3 mm per the dimensioning of the practical embodiment. The bore diameter corresponds to the shaft diameter of the tang 11 of the hooked elements 9. The diameter of the hooked head 13 can be approximately 0.5 mm, i.e., roughly 1.8 times the shaft diameter of the tang 11. These size ratios yield good hooking action of this securing object when in the perforation in the securing surface 3. In the dimensioning of the practical embodiment, the bores are located at intervals relative to one another roughly four times the bore diameter.

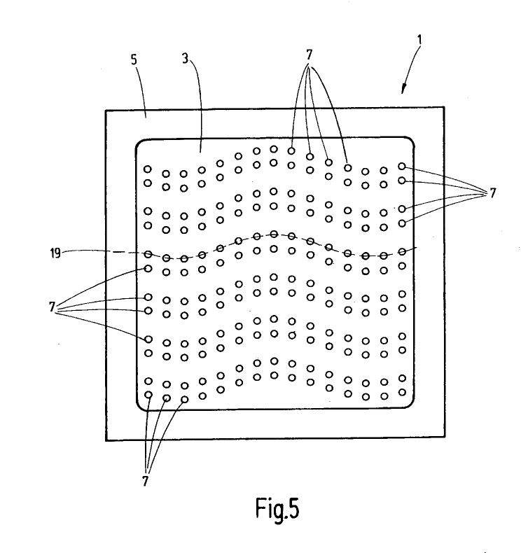

While in the first exemplary embodiment of FIG. 1 the perforation is formed by a bore pattern with bores 7 in straight lines and columns, FIG. 5 shows an alternative exemplary embodiment in which in the securing surface 3 of the backing structure 1 is otherwise made the same as in FIG. 1. A perforation is provided in which bores 7, only partially numbered in FIG. 5, are arranged in a straight line only in columns (in FIG. 5 from top to bottom), but are arranged in succession in lines such that they are arranged in the shape of a sine wave, as indicated in FIG. 5 with the broken line 19. For the securing surface 3 otherwise provided with securing elements 9 analogous to the first embodiment of FIGS. 1-3, a hook pattern arises in which the hook action against relative displacement motions along the backing structure 1 is enhanced compared to the first embodiment.

If the backing structure 1 is a metal part, the securing elements 9 can be advantageously secured by solder connections in the bores 7. For backing structures 1 formed from nonmetal, heat-resistant materials, there can be cement connections. The securing surface 3 can be coated with a cement layer before being provided with the securing elements 9. The tangs 11 of the securing elements 9 are shot through the cement layer into the bores 7. Optionally, a correspondingly chosen cement material can be chemically or thermally activated afterwards. The nonmetal, heat-resistant materials can be ceramic parts or carbon parts. In the case of ceramic materials, perforation can be accomplished preferably prior to sintering, especially when the perforation is to be formed by boring. Depending on the material of the support structure 1 the perforation can be made in some other way, for example, by lasering or punching.

Instead of a backing structure 1 which has a flat securing surface 3 and a square outline shape according to the illustrated embodiments, the backing structure 1 could be made, for example, strip-shaped or band-shaped or rounded in another outline form, and with a securing surface 3 bent out of the plane, not flat, but matched to the surface shape of a pertinent attachment structure.

The perforation of the securing surface 3 need not necessarily be formed by cylindrical bores 7. Holes of another cross-sectional shape could be provided, for example, by punching or lasering. Securing elements with tangs of nonround cross-sectional shape matched accordingly could then be used. Instead of the illustrated through bores, depressions, such as blind holes, closed on the base could be used. More specifically, the designation “perforation” used within the scope of this specification and the claims designates any type of cavities machined into the securing surface 3 and forming the seats for the tangs 11 of the securing elements 9 inserted into them tang first.

While various embodiments have been chosen to illustrate the invention, it will be understood by those skilled in the art that various changes and modifications can be made therein without departing from the scope of the invention as defined in the appended claims.

What is claimed is:

1. A method for producing a heat-resistant adhesive closure, comprising the steps of:
forming a plurality of metal securing elements, each with a hooked head and a foot part formed as a tang having a tang diameter and a tang shape;
forming a backing structure with a securing surface;
perforating the securing surface to form preformed seats with seat diameters and seat shapes for receiving the tangs of the securing elements prior to the securing elements engaging the backing structure, the seat diameters and seat shapes corresponding to the tang diameters and tang shapes, respectively; and
after the perforating, inserting the tangs of the securing elements into the seats previously perforated into the securing surface by the tangs entering the seats first and without the hook heads entering the seats.

2. A method according to claim 1 wherein
the tangs of the securing elements are secured in the seats perforated into the securing surface.

3. A method according to claim 2 wherein
the backing structure is formed of a metal material; and
the tangs are secured in the seats by soldering the tangs to the backing structure.

4. A method according to claim 3 wherein
the tangs are secured in the seats by cementing.

5. A method according to claim 1 wherein
the perforating of the securing surface forms the seats in a bore pattern in which bores are formed in straight columns and rows.

6. A method according to claim 1 wherein
the perforating of the securing surface forms the seats in a bore pattern in which bores are formed in a direction diverging from a straight line.

7. A method according to claim 6 wherein
succeeding bores are formed along a wavy line.

8. A method according to claim 1 wherein
the perforating of the securing surface forms seats in which bores are formed and spaced from one another by a distance approximately four times each seat diameter.

9. A method according to claim 1 wherein
each of the securing elements is formed with a mushroom-shaped hooked head having a diameter approximately 1.8 times each tang diameter thereof.

10. A method for producing a heat-resistant adhesive closure, comprising the steps of:
forming a plurality of metal securing elements, each with a hooked head and a foot part formed as a tang having a tang diameter and a tang shape;
forming a backing structure with a securing surface;
forming cavities in the securing surface to form seats for receiving the tangs of the securing elements prior to the securing elements engaging the backing structure, each cavity having a cavity diameter and a cavity shape corresponding to the respective tang diameter and tang shape, respectively; and
after the cavities are preformed in the securing surface, inserting the tangs of the securing elements into the cavities in the securing surface by the tangs entering the cavities first and without the hooked heads entering the cavities.

11. A method according to claim 10 wherein
the tangs of the securing elements are secured in the cavities of the securing surface.

12. A method according to claim 11 wherein
the backing structure is formed of a metal material; and
the tangs are secured in the cavities by soldering the tangs to the backing structure.

13. A method according to claim 11 wherein
the tangs are secured in the cavities by cementing.

14. A method according to claim 10 wherein
the cavities are formed in a bore pattern in which bores are formed in straight columns and rows.

15. A method according to claim 10 wherein
the cavities are formed in a bore pattern in which bores are formed in a direction diverging from a straight line.

16. A method according to claim 15 wherein
succeeding bores are formed along a wavy line.

17. A method according to claim 10 wherein
the cavities are formed and spaced from one another by a distance approximately four times each cavity diameter.

18. A method according to claim 10 wherein
each of the securing elements is formed with a mushroom-shaped head having a diameter approximately 1.8 times the tang diameter thereof.
